(19) United States
(12) Patent Application Publication
(10) Pub. No.: US 2011/0256280 A1
(43) Pub. Date: Oct. 20, 2011

(54) Stuffed-rim pasta/pizza maker

(76) Inventor: Joseph Saad, Lower Sackville (CA)

(21) Appl. No.: 12/662,451

(22) Filed: Apr. 19, 2010

(51) Int. Cl. A21C 9/06; A21D 13/00

(52) U.S. Cl. 426/283; 99/450.6

(57) ABSTRACT

The apparatus has a hem former that is movable relative to a sheet of dough along an edge of the sheet of dough, for guiding the edge of the sheet of dough in a helical path and for forming a hem along the edge of the sheet of dough. A filling dispenser is mounted near the hem former. The filling dispenser has a discharge chute oriented toward an axis of the helical path for dispensing filling over the edge of the sheet of dough when the edge of the sheet of dough is entering the helical path, prior to forming the hem. In another aspect, there is provided a method for making a sheet of dough with a filling-stuffed rim. This method comprises the steps of spreading filling over the edge of a sheet of dough, and folding the edge of the sheet of dough along a helical path over the filling for forming a hem containing the filling.

### FIELD OF THE INVENTION

This invention pertains especially to apparatus for making pizza crusts with cheese-filled rims, and more particularly, it pertains especially to semi-automatic apparatus for making pizza crusts with cheese-filled rims, one at a time for instant baking and serving to patrons.

### BACKGROUND OF THE INVENTION

Pizza crusts with cheese-filled rims are relatively new in the restaurant industry, and very little prior art has been found to describe a method or an apparatus for making these pizzas. The following document constitutes the only pertinent example found in the prior art.

U.S. Pat. No. 6,479,087 issued to F. Cole et al, on Nov. 12, 2002. This document discloses a machine using cheese extrusion devices mounted on robotic arms to deposit beads of cheese on the edges of several pizza crusts at the time. This machine is built for large production to fulfill a large distributor market for example. The size and cost of this machine are outside the needs of the small and medium size restaurant operators.

Small restaurant bakers have been preparing cheese-filled pizza crusts by hand to satisfy a client demand. However, this client demand is growing and therefore, there is a market need for a semi-automatic apparatus that can be used by bakers of small and large kitchens to improve their efficiencies while improving the consistence of texture and quality of their cheese-crust pizzas.

### SUMMARY OF THE INVENTION

In the present invention, there is provided a semi-automatic stuffed-rim pastry/pizza maker for making a pizza crust with a cheese-filled rim, especially. The word “cheese” is been used hereinbefore because the most popular application for the machine according to the present invention is for filling rims of pizzas with cheese. It is believed that this application is a best one to establish the class of machine to which the present invention pertains.

However, the stuffed-rim pastry/pizza maker according to the present invention can be used to insert other fillings than cheese in the rims of pizzas. These other fillings are numerous and include sauces, spices, ground meat, tomato pastes and purees of vegetables, for examples. Similarly, the machine according to the present invention can also be used to make pies, tarts, turnovers and other pastry products. The fillings that can be used in pies and pastries include chocolate, sugar, jams, jellies, syrup, shredded coconuts and other shredded nuts. Therefore, the word “filling” will be used henceforth to remind the reader that the machine according to the present invention is not limited to stuffing pizza rims with cheese. Similarly, the expression “sheet of dough” will be used hereinafter to designate a pizza crust, a pie crust, a tart crust, a turnover crust and other crusts of baked goods.

Broadly, in one aspect of the present invention, the stuffed-rim pastry/pizza maker has a surface for receiving a sheet of dough thereon; a hem former that is movable relative to a sheet of dough along an edge of the sheet of dough when the sheet of dough is laid on the aforesaid surface. The hem former is used for guiding the edge of the sheet of dough along a helical path and for forming a hem along the edge of the sheet of dough. The stuffed-rim pastry/pizza maker also has a filling dispenser mounted near the hem former. The filling dispenser has a discharge chute that is oriented to deposit filling over a central axis of the helical path, prior to forming the hem.

In another aspect of the present invention, the filling dispenser comprises a cheese shredder, such that the rim of the sheet of dough can be filled with shredded cheese. It will be appreciated that when the filling has a liquid, semi-liquid, paste-like or granular-like consistency, the shredder is replaced by a screw conveyor or it is fed by gravity.

This stuffed-rim pastry/pizza maker is easy to use by bakers for making one pizza at a time for example. The components of the stuffed-rim pastry/pizza maker are of simple construction and can be mounted in different configurations. This stuffed-rim pastry/pizza maker can be manufactured at a reasonable price in order to be accessible to small and medium size restaurant owners.

In yet another aspect of the present invention, there is provided a method for making a sheet of dough with a stuffed rim. This method comprises the steps of spreading filling over the edge of a sheet of dough, and folding the edge of the sheet of dough along a helical path over the filling, for forming a hem containing the filling.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 illustrates a partial plan view of the preferred stuffed-rim pastry/pizza maker;

FIG. 2 is a partial cross-section view of the preferred stuffed-rim pastry/pizza maker as seen along line 2-2 in FIG. 1;

FIG. 3 is a side view of a structural detail in the turn table of the preferred stuffed-rim pastry/pizza maker as seen in detail circle 3 in FIG. 2;

FIG. 4 is a partial perspective view of a preferred curved blade used in the preferred stuffed-rim pastry/pizza maker, for forming a hem;

FIG. 5 is a perspective view of a multiple-disc arrangement to be used as a first alternative to the preferred curved blade illustrated in FIG. 4;

FIG. 6 is a side view of a spoon-like element to be used as a second alternative to the preferred curved blade illustrated in FIG. 4.

### DETAILED DESCRIPTION OF THE PREFERRED EMBODIMENT

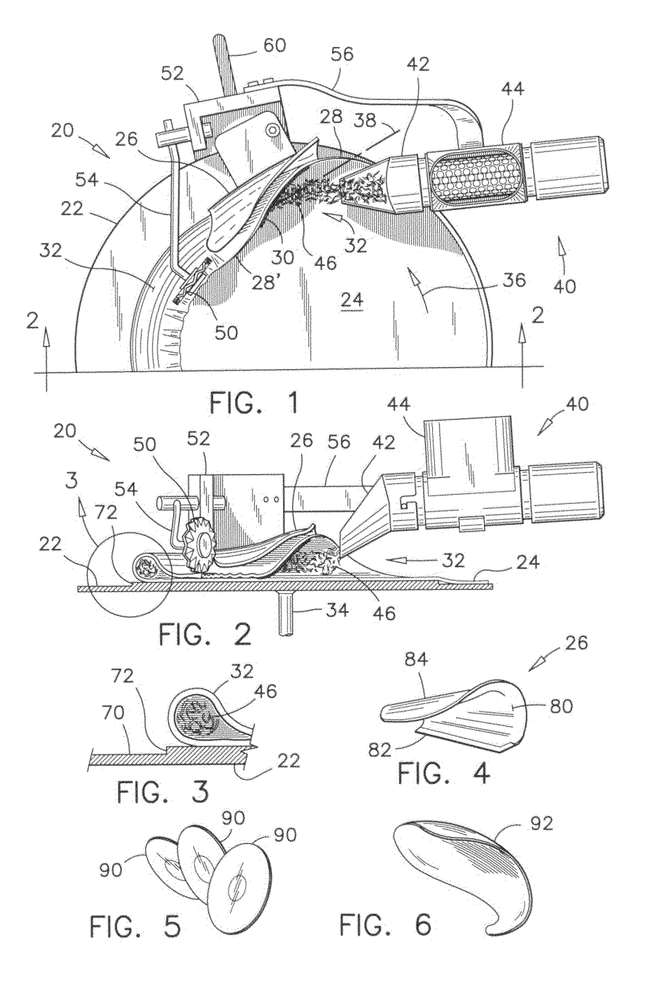

Referring back to FIGS. 1 and 2, there is illustrated therein, a preferred embodiment of the stuffed-rim pastry/pizza maker. It will be appreciated that numerous parts were omitted in the drawings for clarity. The preferred stuffed-rim pastry/pizza maker has a cover; a base; several control buttons; a controller; one or more motors; position switches; actuators and other hardware known in the field of machine design. These elements and instruments do not constitute the focus of the present invention, and therefore they have not been illustrated. Also, the drawings were prepared in a schematic manner to facilitate the illustration of the operation of the stuffed-rim pastry/pizza maker.

The preferred stuffed-rim pastry/pizza maker 20 has a circular table 22 on which a disc of dough referred to herein as a sheet of dough 24 is placed. A curved blade 26 is mounted over the table 22. This curved blade 26 has a curvature such as a snow plow whereby it has the ability to turn the edge 28 of a sheet of dough 24 over itself in a helical path 30 to form a hem 32 along the rim of the sheet of dough 24.

The table 22 is preferably rotatable on a shaft 34 by a motor which has not been illustrated for clarity. The direction of rotation of the table 22 is indicated by arrow 36. Similarly, the central axis of the helical path 30 is being represented by label 38.

The preferred stuffed-rim pastry/pizza maker 20 has a filling dispenser 40 which has a discharge chute 42 oriented into the hem 32 being formed by the curved blade 26, as it can be appreciated from the drawings.

The preferred filling dispenser 40 is a motor-operated cheese shredder that has a feed hopper 44. The cheese to be shred is preferably forced fed in the hopper 44 by a spring loaded cover or otherwise. A spring-loaded cover or a weighted plunger has not been illustrated because it is also known to those skilled in the art of cheese-shredding hoppers.

The shredded cheese 46 is placed on the sheet of dough 24 in such a way as to be enclosed inside the hem 32. For more clarity, the shredded cheese 46 is dispensed over the central axis 38 of the helical path 30, upstream from the hem 32.

The preferred stuffed-rim pastry/pizza maker 20 also has a hem sealer 50 that is mounted to a same base structure 52 as the curved blade 26. The hem sealer 50 has a preferred form of a wheel mounted on a rod 54 extending from the base structure 52. In use, the hem sealer 50 is forced down against the sheet of dough 24 on top of the folded edge 28′ to rotate with a slight pressure against the folded edge 28′ to close the hem 32 by slight pressure deformation, as the sheet of dough 24 rotates.

The hem sealer 50 is not considered as being essential to the operation of the preferred stuffed-rim pastry/pizza maker 20, because some bakers may prepare pastry products without sealing the hem 32, or may prefer to close the hem 32 themselves by hand. For this reason, the hem sealer 50 is preferably mounted in a movable manner so that it can be selectively deployed or moved away from the process.

The filling dispenser 40 is also mounted to the base structure 52 by means of a brace 56 or a similar structure, such that the discharge chute 42 of the filling dispenser 40 remains in alignment with the mouth of the curved blade 26, or as mentioned before, it remains in alignment to deposit filling over the central axis 38 of the helical path 30.

Again, the mechanism for raising or for lowering the hem sealer 50 has not been illustrated, for clarity. Many conventional actuators can be used for this purpose.

The base structure 52 is movable toward and away from the table 22 along a slot 60 for example extending radially from the table 22. The purpose of this movement of the base structure 52 is to bring the curved blade 26 in operating position against and under the edge 28 of a sheet of dough 24 when initiating a rim filling operation.

A common mounting of the filling dispenser 40, the hem sealer 50 and the curved blade 26 to the base structure 52 is to ensure that three elements can be moved in unison while keeping their mutual alignment.

The mechanism that is used for moving the base structure 52 radially has not been illustrated because many arrangements that are well known in the art can be used to perform this function.

Another purpose of the movement of the base structure 52 along the slot 60 is to accommodate for the making of sheets of dough of different diameters. In that case, the table 22 is preferably replaced by one that has a similar diameter as the sheet of dough to be formed. The support structure 52 is then positioned to operate within a range that is appropriate for the diameter of the table 22 being used.

Referring now to FIG. 3, a structural detail of the preferred circular table 22 will be explained. The table 22 is preferably made with a reduced thickness along the outer edge thereof, as shown at label 70. This reduced thickness 70 is machined from the table surface 22 in a way to provide a shoulder 72 on that surface. This shoulder 72 constitutes a guide against which the curved blade 26 is held when folding a sheet of dough 24. This shoulder 72 provides a reliable reference for producing sheets of dough with consistent dimensions and quality. It will be understood that a separate plate having a similar shoulder as at label 72 can also be used in the preferred embodiment and mounted on a conventional turn table not having a reduced thickness.

The preferred curved blade 26 is illustrated with more clarity in FIG. 4. The curved blade 26 has a mouth portion 80 to receive the edge 28 of a sheet of dough 24. The curved blade 26 also has a tapered lip 82 along its lower portion, to slide under the edge 28 of the sheet of dough 24 and to abut against the shoulder 72 on the turn table 22. The preferred curved blade 26 has a funnel shape 84 for better forming and closing the hem 32 mentioned above.

Although the elements illustrated in FIGS. 5 and 6 have not been tested in use, it is believed that these elements can also be used to fold a hem in a sheet of dough. This assumption is made from experience with the operation of the preferred embodiment described herein. Therefore, it is submitted that an acceptable operation of the stuffed-rim pastry/pizza maker 20 can also be achieved using one the following elements in replacement of the curved blade 26 mentioned herein above.

The first alternate arrangement for a hem former is illustrated in FIG. 5 as a series of inclined discs 90 arranged at different angles substantially as illustrated. The other alternate arrangement is a spoon-like element 92 to be used with or without a guiding shoulder 72. For example, a programmable actuator may be used to hold the spoon-like element 92 in a proper position.

Although the preferred embodiment has been illustrated as an stuffed-rim pastry/pizza maker where the sheet of dough is rotated under a filling dispenser, those skilled in the art will understand that another embodiment can be made with the sheet of dough remaining stationary while a filling dispenser 40 and a curved blade 26 are moved around the sheet of dough, on a robotic arm for example. Also, it will be appreciated that obvious modification can be used to accommodate square or rectangular sheets of dough. Therefore, the above description should not be construed as limiting the scope of the present invention.

What is claimed is:

1. A stuffed-rim pastry/pizza maker for making a sheet of dough with a filling-stuffed rim, comprising;
a surface for receiving said sheet of dough thereon;
a hem former movably mounted thereto relative to said sheet of dough along an edge of said sheet of dough when said sheet of dough is laid on said surface, for guiding said edge of said sheet of dough in an helical path and for forming a hem along said edge of said sheet of dough;
a filling dispenser mounted near said hem former; said filling dispenser having a discharge chute oriented toward an axis of said helical path for dispensing filling over said edge of said sheet of dough when said edge of said sheet of dough is entering said helical path.

2. The stuffed-rim pastry/pizza maker for making a sheet of dough with a filling-stuffed rim as claimed in claim 1, wherein said surface is a rotatable circular table.

3. The stuffed-rim pastry/pizza maker for making a sheet of dough with a filling-stuffed rim as claimed in claim 1, wherein said filling dispenser comprises a cheese shredder.

4. The stuffed-rim pastry/pizza maker for making a sheet of dough with a filling-stuffed rim as claimed in claim 1, wherein said hem former is a spoon-like element.

5. The stuffed-rim pastry/pizza maker for making a sheet of dough with a filling-stuffed rim as claimed in claim 1, wherein said hem former is a series of inclined discs.

6. A stuffed-rim pastry/pizza maker for making a sheet of dough with a filling-stuffed rim, comprising;
a turn table for receiving said sheet of dough thereon;
a curved blade mounted thereto near an edge of said sheet of dough when said sheet of dough is laid on said turn table; said curved blade having a tapered lip for engaging under said edge of said sheet of dough when said turn table is turning; a mouth portion for guiding said edge of said sheet of dough in a helical path when said turn table is turning; and a funnel shape for forming a hem along said edge of said sheet of dough when said turn table is turning;
a filling dispenser mounted near said mouth portion of said curved blade; said filling dispenser having a discharge chute oriented toward said mouth portion for dispensing filling over said edge of said sheet of dough when said edge of said sheet of dough is entering said mouth portion of said curved blade.

7. The stuffed-rim pastry/pizza maker for making a sheet of dough with a filling-stuffed rim as claimed in claim 6, further comprising a wheel mounted thereto near said curved blade for rotation over said edge when said edge is folded, for sealing said hem by pressure deformation.

8. The stuffed-rim pastry/pizza maker for making a sheet of dough with a filling-stuffed rim as claimed in claim 6, wherein said wheel is movably mounted thereto for selective movement between a deployed position and a retracted position.

9. The stuffed-rim pastry/pizza maker for making a sheet of dough with a filling-stuffed rim as claimed in claim 6, wherein said filling dispenser comprises a cheese shredder.

10. The stuffed-rim pastry/pizza maker for making a sheet of dough with a filling-stuffed rim as claimed in claim 6, wherein said curved blade is mounted to a base structure and said base structure is movable radially relative to said turn table.

11. The stuffed-rim pastry/pizza maker for making a sheet of dough with a filling-stuffed rim as claimed in claim 6, wherein said turn table has a circular shoulder in a surface thereof for guiding said curved blade.

12. The stuffed-rim pastry/pizza maker for making a sheet of dough with a filling-stuffed rim as claimed in claim 10, wherein said curved blade, said wheel and said filling dispenser are mounted to said base structure and are movable in unison with said base structure.

13. A method for making a sheet of dough with a filling-stuffed rim, comprising the steps of;
spreading filling on an edge of said sheet of dough; and
folding said edge along a helical path over said filling and forming a hem containing said filling.

14. The method for making a sheet of dough with a filling-stuffed rim as claimed in claim 13, further comprising the step of sealing said hem.

15. The method for making a sheet of dough with a filling-stuffed rim as claimed in claim 13, wherein said step of spreading filling on said edge comprises the step of spreading filling along an axis of said helical path.

16. The method for making a sheet of dough with a filling-stuffed rim as claimed in claim 13, wherein said sheet of dough is circular, further comprising the step of rotating said sheet of dough during said steps of spreading and folding.

17. The method for making a sheet of dough with a filling-stuffed rim as claimed in claim 13, further comprising the step of causing said helical path to move along said edge.

18. The method for making a sheet of dough with a filling-stuffed rim as claimed in claim 17, wherein said step of spreading comprises spreading along said edge.

19. The method for making a sheet of dough with a filling-stuffed rim as claimed in claim 15, further comprising the step of causing said helical path to move along said edge.

20. The method for making a sheet of dough with a filling-stuffed rim as claimed in claim 19, wherein said step of spreading comprises spreading along said edge.
